(19) United States
(12) Patent Application Publication
(10) Pub. No.: US 2010/0260322 A1
(43) Pub. Date: Oct. 14, 2010

(54) X-RAY GENERATOR EMPLOYING HEMIMORPHIC CRYSTAL

(75) Inventors: Yoshiaki Ito, Kyoto (JP); Shinzo Yoshikado, Kyoto (JP); Yoshikazu Nakanishi, Shiga (JP); Shinji Fukao, Kyoto (JP); Toru Nakamura, Kyoto (JP); Shigeo Ito, Chiba (JP); Takeshi Tonegawa, Chiba (JP); Yohei Fujimura, Chiba (JP)

Correspondence Address: Kirschstein, Israel, Schiffmiller & Pieroni, P.C., 425 FIFTH AVENUE, 5TH FLOOR, NEW YORK, NY, 10016-2223, US

(73) Assignees: KYOTO UNIVERSITY, Kyoto (JP); THE DOSHISHA, Kyoto (JP); ASAHI ROENTGEN IND. CO., LTD., Kyoto (JP); FUTABA CORPORATION, Chiba (JP)

(21) Appl. No.: 12/739,986

(22) PCT Filed: Oct. 22, 2008
(86) PCT No.: PCT/JP2008/069119

§ 371 Date: Jun. 10, 2010

(30) Foreign Application Priority Data
Oct. 30, 2007 (JP) 2007-281612
Oct. 22, 2008 (JP) PCT/JP2008/069119

(51) Int. Cl. H01J 35/06

(52) U.S. Cl. 378/122

(57) ABSTRACT

An X-ray generator comprises a container (1) for maintaining a high vacuum or low pressure gas atmosphere internally, a hemimorphic crystal (4), temperature raising/lowering means (3, 5-7), and a metal target (8) for generating X-rays. In this X-ray generator the metal target (8) has a pointed protrusion protruding toward the hemimorphic crystal (4). When X-rays are generated by raising/lowering the temperature of the hemimorphic crystal (4) by using the temperature raising/lowering means (3, 5-7), the intensity of an electric field formed between the hemimorphic crystal (4) and the metal target (8) increases at the pointed end of the protrusion and thus the intensity of X-rays generated through collision of electrons against the metal target (8) increases. Consequently, an X-ray generator employing a hemimorphic crystal, which is capable of generating X-rays with practically sufficient intensity can be provided.

### TECHNICAL FIELD

The present invention relates to an X-ray generator employing a hemimorphic crystal (also referred to as pyroelectric crystal).

### BACKGROUND ART

An X-ray generator employing a hemimorphic crystal such as lithium niobate (LiNbO₃) or lithium tantalate (LiTaO₃) is compact, lightweight, and excellent in portability because it requires no high-voltage power supply and, therefore, has been highly expected as an X-ray source in place of conventional X-ray tubes (e.g., see Patent Document 1).

A conventional X-ray generator employing a hemimorphic crystal is characterized by raising and lowering the temperature of the hemimorphic crystal to generate electron beam from the crystal, colliding the electron beam against a metal foil target, and radiating X-rays on a straight line which connects the crystal and the center of the target.

However, the X-rays generated from the X-ray generator has not enough intensity to apply, for example, X-ray photography, X-ray analysis, or the like.

Patent Document 1: Japanese Laid-Open Patent Publication No. 2005-174556

### DISCLOSURE OF THE INVENTION

### Problems to be Solved by the Invention

It is, therefore, an object of the present invention to provide an X-ray generator employing a hemimorphic crystal capable of generating X-rays with enough intensity to apply practical use.

### Means for Solving the Problems

In order to achieve the object, according to the present invention, there is provided an X-ray generator comprising: a container for maintaining a high vacuum or low pressure gas atmosphere therein; a hemimorphic crystal arranged in the container; a means for raising and lowering the temperature of the hemimorphic crystal; and a metal target for X-ray generation arranged in the container in such a way that the metal target is positioned within a range reachable by an electric field generated from the hemimorphic crystal thermally excited by the means for raising and lowering the temperature so as to receive electron beam irradiation from the hemimorphic crystal, wherein the metal target is arranged opposite to the hemimorphic crystal at a spacing therebetween and provided with at least one pointed projection extending toward the hemimorphic crystal, whereby the intensity of the electric field generated from the hemimorphic crystal is increased at the tip section of the at least one projection of the metal target.

According to a preferable embodiment of the present invention, the tip section of said metal target is made of one or more metals or an alloy thereof, the one or more metals being different from the metal (s) of which the rest of the metal target is made.

According to another preferable embodiment of the present invention, the metal target is formed in a conical shape, a pyramidal shape, a columnar shape whose end face is cut obliquely, or a blade or rod shape with a pointed end.

According to further preferable embodiment of the present invention, the means for raising and lowering the temperature comprises: a temperature sensor for measuring the temperature of the hemimorphic crystal; a heater-cooler capable of repeatedly heating and cooling the hemimorphic crystal; and a control means for controlling the operation of the heater-cooler based on temperature detection signals from the temperature sensor.

According to further preferable embodiment of the present invention, the wall of the container is made of a radiopaque material and provided with an X-ray transmissive window for radiating X-rays emitted from the metal target to the outside.

### EFFECT OF THE INVENTION

According to the present invention, when an electric field which points from a hemimorphic crystal toward the metal target is generated by thermal excitation of the hemimorphic crystal, this electric field is extremely intensified at the tip section of the projection of the metal target. Then field emission is induced by the electric field so that electrons are emitted from the tip section of the metal target and accumulated on the surface of the hemimorphic crystal. When an electric field which points from the metal target toward the hemimorphic crystal is generated, the electric field is extremely intensified at the tip section of the projection of the metal target in a similar way, and when the inside of the container is maintained as a high vacuum, the electrons generated by the field emission collide against the metal target and X-rays are generated from the metal target. On the other hand, when a low pressure gas atmosphere is maintained in the container, electrons accumulated on the surface of the hemimorphic crystal collide against the metal target together with the electrons and ions which are generated by ionization of atoms and molecules of residual gas and X-rays are generated from the metal target. Consequently, according to the present invention, the X-ray intensity can be increased by intensifying the electric field which points from the hemimorphic crystal to the metal target or from the metal target to the hemimorphic crystal.

### BRIEF DESCRIPTION OF DRAWINGS

FIG. 1 is a schematic view of an X-ray generator employing a hemimorphic crystal according to the present invention.

FIG. 2 is a schematic view of various examples of a metal target.

FIG. 3 is a schematic view of an embodiment of the present invention.

FIG. 4 is a schematic view of a comparative example.

FIG. 5 is a graph comparing X-ray intensity of the embodiment of the present invention and that of the comparative example.

### EXPLANATION OF REFERENCE NUMERALS

1 Container
2 X-ray transmissive window
3 Peltier device
4 Hemimorphic crystal
5 Temperature sensor
6 Control unit
7 Power supply unit
8 Metal target

### BEST MODE FOR CARRYING OUT THE INVENTION

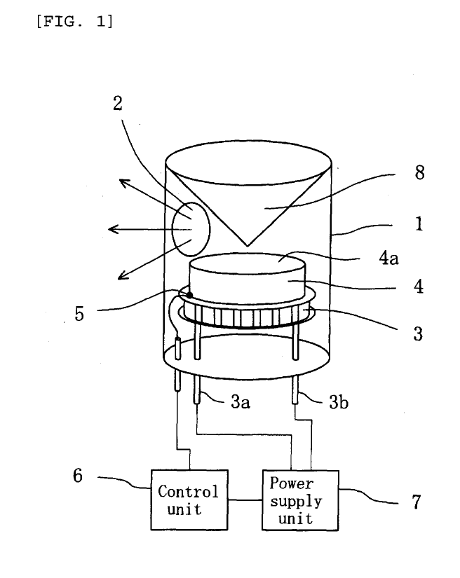

Hereinafter, a preferable embodiment of the present invention will be described with reference to attached drawings. FIG. 1 is a cross-sectional view showing a schematic configuration of an X-ray generator employing a hemimorphic crystal according to an embodiment of the present invention. Referring to FIG. 1, the X-ray generator of the present invention has a container 1 for maintaining, for example, high vacuum or a low pressure gas atmosphere (1 to 10⁻⁴ Pa) of nitrogen, neon, helium or the like therein. In this embodiment, the container 1 is made of a radiopaque material and has a cylindrical shape with closed both ends. The shape of the container 1 is not limited to this embodiment and a container of an arbitrary shape can be used. The container 1 has an X-ray transmissive window 2 at its peripheral wall. The X-ray transmissive window is made of Beryllium (Be) or radiolucent plastic.

A Peltier device 3 is arranged at the bottom of the container 1. Electrodes 3a, 3b of the Peltier device 3 are attached to the bottom wall of the container 1 in airtight manner and pass through the bottom wall. In this embodiment, the Peltier device 3 serves as not only a heater-cooler for repeatedly heating and cooling a hemimorphic crystal but also a means for supporting the hemimorphic crystal. The hemimorphic crystal 4 is attached and supported on the upper substrate of the Peltier device 3. In this case, a hemimorphic crystal is spontaneously polarized at normal temperature in such a way that one end surface of the crystal is positively charged and the other end surface of the crystal is negatively charged. In this embodiment, the hemimorphic crystal 4 is arranged on the upper substrate of the Peltier device 3 in such a manner that the negatively charged surface 4a of the crystal 4 is directed upward. Alternatively, the hemimorphic crystal 4 may be arranged on the upper substrate of the Peltier device 3 in such a manner that the positively charged surface of the crystal 4 is directed upward.

Well-known hemimorphic crystals such as LiNbO₃ and LiTaO₃ can be used as the hemimorphic crystal 4. The shape and the size of the hemimorphic crystal 4 are not particularly limited. However, in this embodiment, the hemimorphic crystal 4 has a columnar shape with a diameter of about 10 mm and a thickness of about 5 mm.

At the outside of the container 1, a power supply unit 7 such as a battery and a control unit 6 are arranged. The power supply unit 7 supplies electric power to the Peltier device 3. The control unit 6 switches the direction of electric current supplied to the Peltier device 3 so as to allow the surface of the upper substrate of the Peltier device 3 to operate as a heat generation surface and a heat absorption surface. A temperature sensor 5 is attached to the hemimorphic crystal 4 and the control unit 6 controls the operation of the Peltier device 3 based on detection signals of the temperature sensor 5.

The Peltier device 3, the temperature sensor 5, the power supply unit 7, and the control unit 6 constitute a means for raising and lowering the temperature of the hemimorphic crystal 4. The means 3, 5-7 for raising and lowering the temperature can raise and lower the temperature of the hemimorphic crystal 4 with various temperature gradients, various cycles, or non-periodically. In this case, preferably, durations of temperature rise and temperature fall are equal to each other for each heating-cooling cycle and the heating-cooling cycles are preferably created between a room temperature and an arbitrary high temperature which is equal to or lower than the Curie temperature of the hemimorphic crystal 4.

The hemimorphic crystal 4 is spontaneously polarized in the steady state and electric charges induced by the spontaneous polarization are electrically balanced out by counter electric charges which absorb onto the surface of the crystal 4, and thereby the hemimorphic crystal is electrically neutral. When the hemimorphic crystal 4 is repeatedly heated and cooled, the spontaneous polarization of the crystal 4 is dramatically altered with changes in the temperature of the crystal 4 and the counter electric charges adsorbed onto the surface of the crystal 4 cannot electrically balance the polarization charge, and a strong electric field is generated around the crystal due to the break of electric balance. Thus, when the hemimorphic crystal 4 is heated and cooled by the means 3, 5-7 for raising and lowering the temperature, an electric field which points toward the outside of the hemimorphic crystal 4 or toward the hemimorphic crystal 4 is generated.

A metal target 8 for X-ray generation is arranged opposite to the hemimorphic crystal 4 at a spacing therebetween in the container 1 in such a way that the metal target 8 is positioned within a range reachable by the electric field generated from the hemimorphic crystal 4. In this case, the intensity of the X-ray is changed with changes in the spacing between the metal target 8 and the hemimorphic crystal 4.

In this embodiment, the metal target 8 of conical shape is attached to the upper wall of the container 1 in such a way that the tip of the metal target 8 faces the hemimorphic crystal 4 and the sloping surface of the metal target 8 faces the X-ray transmissive window 2 of the container 1. When the metal target has a conical shape, the intensity of X-rays to be generated depends on a central angle of the cone. When the central angle is 90°, the electric field has the maximum intensity at the tip of the cone and thus the X-ray intensity reaches the maximum.

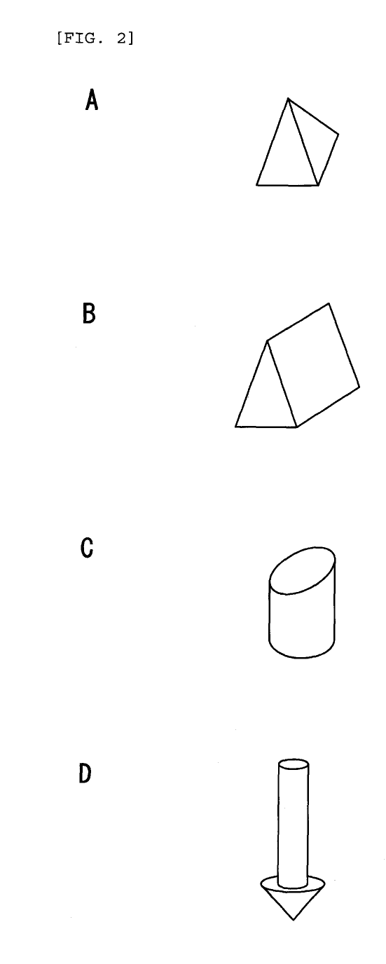

The shape of the metal target 8 is not limited to this embodiment and a metal target of arbitrary shape which has at least one pointed projection extending toward the hemimorphic crystal 4 may be used. For example, the metal target 8 may have a pyramidal shape as shown in FIG. 2(A), an wedge shape as shown in FIG. 2(B), a columnar shape whose end face is cut obliquely as shown in FIG. 2(C), or a rod shape whose tip portion is conical as shown in FIG. 2(D).

The metal target 8 may be made of material suitable for characteristics and intended use of X-rays to be generated. For example, when the X-ray generator of the present invention is applied to an X-ray analyzer, the metal target 8 may be made of Al, Mg, Cu, or the like suitable for the analysis.

The tip section of the metal target 8 is made of one or more metals or an alloy thereof, the one or more metals being different from the metal (s) of which the rest of the metal target 8 is made. In this case, a point-like X-ray source is formed.

A method of operation of the X-ray generator of the present invention will be explained. In the following explanation, the container of the apparatus maintains low pressure gas atmosphere therein.

The hemimorphic crystal 4 is spontaneously polarized in the steady state and electric charges induced by the spontaneous polarization are electrically balanced out by counter electric charges which absorb onto the surface of the crystal 4, and thereby the hemimorphic crystal is electrically neutral. As the hemimorphic crystal 4 is heated, the spontaneous polarization per unit area on the negatively charged surface 4a of the crystal 4 decreases, which causes decrease in the surface density of negative charges, but counter charges (positive charges) absorbed on the surface of the crystal 4 are not decreased at the same timing as the decrease in the polarization. As a result, the negatively charged surface 4a is positively charged and accordingly a strong electric field which points from the hemimorphic crystal 4 toward the metal target 8 is generated. This electric field is intensified at the tip section of the metal target 8

Gas atoms and molecules of the residual gas or the like in the container are ionized to produce positive ions and electrons by the action of the electric field, and electrons are emitted from the tip section of the metal target 8 by field emission which is induced by the electric field. These electrons collide against the negatively charged surface 4a of the hemimorphic crystal 4 or are adsorbed by the positive ions adsorbed on the negatively charged surface 4a (when being observed from the outside, the positive charges of the positive ions are electrically balanced out by the negative charges of the spontaneous polarization). When the electrons collide against the negatively charged surface 4a of the hemimorphic crystal 4, characteristic X-rays of the hemimorphic crystal 4 and continuous X-rays are generated through braking radiation.

Next, as the hemimorphic crystal 4 is cooled, the spontaneous polarization per unit area on the negatively charged surface 4a of the crystal 4 increases, which causes increase in the surface density of the negative charge, but counter charges (positive charges) absorbed on the surface of the crystal 4 are not increased at the same timing as the increase in the polarization. As a result, the negatively charged surface 4a is negatively charged and accordingly a strong electric field which points from the metal target 8 toward the hemimorphic crystal 4 is generated. This electric field is intensified at the tip section of the metal target 8

In this case, no electron is emitted from the metal target 8 because the electric field points in a direction opposite to the direction of the electric field generated in the heating process. On the other hand, gas atoms and molecules of the residual gas are ionized to produce electrons by the action of the electric field. In addition, the positive ions to which electrons are adsorbed are ionized again due to the action of the electric field so that positive ions and electrons are produced. These electrons are accelerated toward the metal target 8 so as to collide against the metal target 8, and accordingly characteristic X-ray inherent in constitutive substance (s) of the metal target 8 and continuous X-ray are generated through braking radiation. According to the present invention, the electric field which points from the hemimorphic crystal 4 to the metal target 8 or from the metal target 8 to the hemimorphic crystal 4 is intensified and thereby very strong X-rays can be generated.

In this case, because the surface of the metal target 8 which the electrons collide against is inclined, X-ray is radiated in a traverse direction with respect to a direction in which the electrons collide and emitted outside through the X-ray transmissive window 2. According to this embodiment, unlike the case of using a conventional metal foil target, the generated X-rays do not pass through the metal target and is not absorbed in the metal target. Consequently, stronger X-rays are emitted through the X-ray transmissive window 2.

As the hemimorphic crystal 4 is further cooled, the hemimorphic crystal 4 moves to the steady state again and electric charges induced by the spontaneous polarization are electrically balanced out by counter electric charges which absorb onto the surface of the crystal 4, and thereby the hemimorphic crystal is electrically neutral.

According to another embodiment of the present invention, the container maintains a high vacuum therein. This embodiment differs from the above-mentioned embodiment in only the point that no positive ion and no electron are generated by the ionization of the gas atoms and molecules because a gas scarcely remains in the container.

An Experiment was carried out to prove the effects of the X-ray generator according to the present invention.

### Embodiment

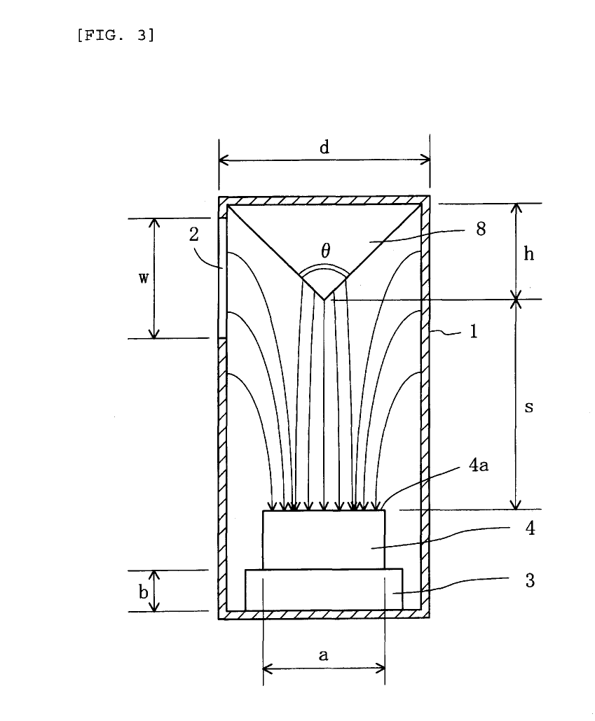

As shown in FIG. 3, a stainless steel container 1 having a cylindrical shape whose both ends are closed and having an inner diameter d of 16 mm was prepared. A Peltier device 3 was arranged in the container 1 and a lithium niobate crystal 4 of columnar shape having a diameter a of 10 mm and a thickness b of 5 mm was arranged on the upper substrate of the Peltier device 3 in such a manner that a negatively charged surface 4a of the crystal 4 faces upward. A conical copper (Cu) target 8 (with a central angle of 90°) having a diameter d of 16 mm and a height h of 8 mm was attached to the upper wall surface in the interior of the container 1. The distance between the tip of the target 8 and the negatively charged surface 4a of the crystal 4 was set to be 17.5 mm. An X-ray transmissive window 2 made of Beryllium (Be) which has a circular shape with a diameter of 10 mm was formed on the peripheral wall of the container 1 in such a way that the window 2 faces the sloping surface of the conical copper target 8.

### Comparative Example

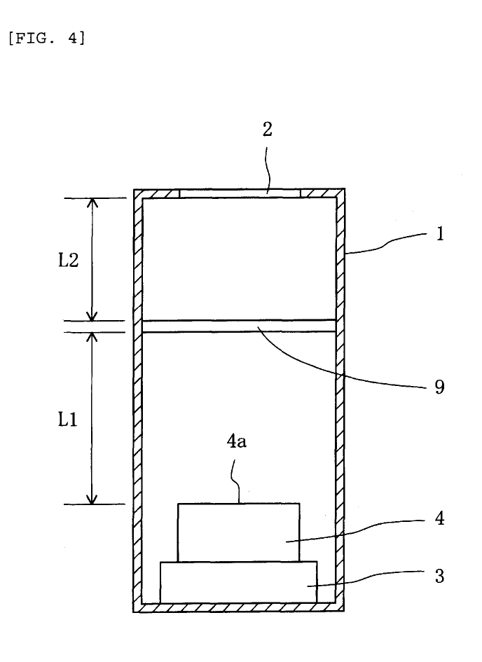

As shown in FIG. 4, the same cylindrical stainless steel container 1 as the embodiment was prepared and the same Peltier device 3 as the embodiment was arranged in the container. The same hemimorphic crystal 4 as the embodiment was arranged on the upper substrate of the Peltier device 3 in such a way that the negatively charged surface 4a faces upward. A copper foil which has a diameter of 16 mm as a metal target 8′ was arranged opposite to the negatively charged surface 4a of the crystal 4 at a spacing L1 of 16 mm therebetween. The same X-ray transmissive window 2 as the embodiment was formed on the upper wall of the container 1. In this case, the distance L2 between the X-ray transmissive window 2 and the metal target 8′ was set to be 11 mm.

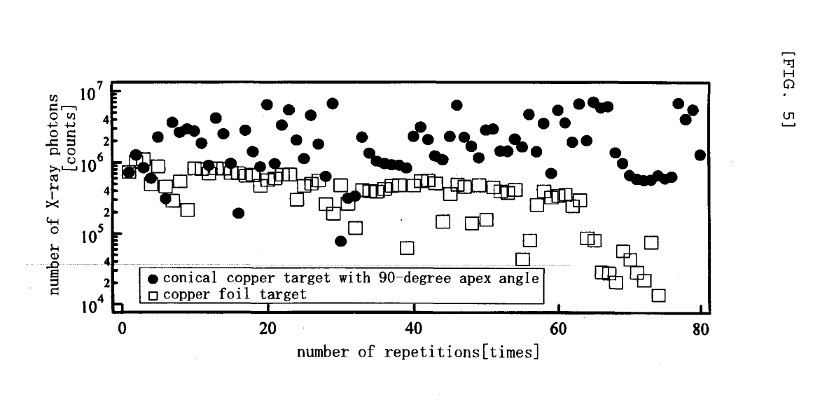

In each of the embodiment and the comparative example, the inside of the container was maintained as high vacuum (10⁻⁴ Pa), the electric power of 2V-1 A was supplied to the Peltier device, the temperature of the hemimorphic crystal 4 was raised and lowered within a temperature range of 5 to 80° C., and the intensity (cps) of the generated X-rays was measured. The result of the measurement is shown in a graph of FIG. 5. In the graph of FIG. 5, the ordinate axis represents the X-ray intensity (cps) and the abscissa axis represents the number of repetitions of heating-cooling. It has been ascertained from the graph of FIG. 5 that the X-ray intensity of the embodiment is about 10 times stronger than that of the comparative example.

Thus it was made clear that the conical metal target of the present invention generates stronger X-rays than the conventional metal foil target. In addition, the conical metal target can radiate X-rays in the traverse direction with respect to a straight line connecting the center of the hemimorphic crystal and the center of the metal target, whereas the conventional metal foil target radiates X-rays in a direction of the straight line connecting the center of the hemimorphic crystal and the center of the metal target. Accordingly, use of the X-ray generator of the invention as an X-ray source of a compact size X-ray photographing apparatus or a compact size fluorescent X-ray analyzer can greatly expand the possibility of design.

1-5. (canceled)

6. An X-ray generator comprising:
a container for maintaining a high vacuum or low pressure gas atmosphere therein;
a hemimorphic crystal arranged in said container;
means for raising and lowering a temperature of said hemimorphic crystal; and
a metal target for X-ray generation arranged in said container in such a way that said metal target is positioned within a range reachable by an electric field generated from said hemimorphic crystal thermally excited by said means for raising and lowering the temperature so as to receive electron beam irradiation from said hemimorphic crystal, wherein
said metal target is arranged opposite to said hemimorphic crystal at a spacing therebetween and provided with at least one pointed projection extending toward said hemimorphic crystal, whereby an intensity of said electric field generated from said hemimorphic crystal is increased at a tip section of said at least one projection of said metal target.

7. The X-ray generator according to claim 6, wherein said tip section of said metal target is made of one or more metals or an alloy thereof, said one or more metals being different from the metal or metals of which a rest of said metal target is made.

8. The X-ray generator according to claim 6, wherein said metal target is formed in one of a conical shape, a pyramidal shape, a columnar shape whose end face is cut obliquely, and a blade or rod shape with a pointed end.

9. The X-ray generator according to claim 6, wherein said means for raising and lowering the temperature comprises:
a temperature sensor for measuring the temperature of said hemimorphic crystal;
a heater-cooler capable of repeatedly heating and cooling said hemimorphic crystal; and
control means for controlling operation of said heater-cooler based on temperature detection signals from said temperature sensor.

10. The X-ray generator according to claim 6, wherein a wall of said container is made of a radiopaque material and provided with an X-ray transmissive window for radiating X-rays emitted from said metal target to outside.
